(19) United States
(12) Patent Application Publication
(10) Pub. No.: US 2025/0119367 A1
(43) Pub. Date: Apr. 10, 2025

(54) UNIQUE ID GENERATION FOR SENSORS

(71) Applicant: Cisco Technology, Inc., San Jose, CA (US)

(72) Inventors: Abhishek Ranjan Singh, Pleasanton, CA (US); Shih-Chun Chang, San Jose, CA (US); Varun Sagar Malhotra, Sunnyvale, CA (US); Hai Trong Vu, San Jose, CA (US); Jackson Ngoc Ki Pang, Sunnyvale, CA (US)

(21) Appl. No.: 18/981,759

(22) Filed: Dec. 16, 2024

Related U.S. Application Data
(63) Continuation of application No. 18/322,807, filed on May 24, 2023, now Pat. No. 12,231,308.
Application No. 18/322,807 is a continuation of application No. 16/941,426, filed on Jul. 28, 2020, now Pat. No. 11,695,659.
Application No. 16/941,426 is a continuation of application No. 15/163,605, filed on May 24, 2016, now Pat. No. 10,735,283.
(60) Provisional application No. 62/171,899, filed on Jun. 5, 2015.

(51) Int. Cl. H04L 43/045; G06F 3/0482; G06F 3/04842; G06F 3/04847; G06F 9/455; G06F 16/11; G06F 16/13; G06F 16/16; G06F 16/17; G06F 16/174; G06F 16/23; G06F 16/2457; G06F 16/248; G06F 16/28; G06F 16/29; G06F 16/9535; G06F 21/53; G06F 21/55; G06F 21/56; G06N 20/00; G06N 99/00; G06T 11/20; H04J 3/06; H04J 3/14; H04L 1/24; H04L 7/10; H04L 9/08; H04L 9/32; H04L 9/40; H04L 41/046; H04L 41/0668; H04L 41/0803; H04L 41/0806; H04L 41/0816; H04L 41/0893; H04L 41/12; H04L 41/16; H04L 41/22; H04L 43/02; H04L 43/026; H04L 43/04; H04L 43/062; H04L 43/08; H04L 43/0805; H04L 43/0811; H04L 43/0829; H04L 43/0852; H04L 43/0864; H04L 43/0876; H04L 43/0882; H04L 43/0888; H04L 43/10; H04L 43/106; H04L 43/12; H04L 43/16; H04L 45/00; H04L 45/302; H04L 45/50; H04L 45/74; H04L 47/11; H04L 47/20; H04L 47/2441; H04L 47/2483; H04L 47/28; H04L 47/31; H04L 47/32; H04L 61/5007; H04L 67/01; H04L 67/10; H04L 67/1001; H04L 67/12; H04L 67/50; H04L 67/51; H04L 67/75; H04L 69/16; H04L 69/22; H04W 72/54; H04W 84/18

(52) U.S. Cl. CPC H04L 43/045; G06F 3/0482; G06F 3/04842; G06F 3/04847; G06F 9/45558; G06F 16/122; G06F 16/137; G06F 16/162; G06F 16/17; G06F 16/173; G06F 16/174; G06F 16/1744; G06F 16/1748; G06F 16/2322; G06F 16/235; G06F 16/2365; G06F 16/24578; G06F 16/248; G06F 16/285; G06F 16/288; G06F 16/29; G06F 16/9535; G06F 21/53; G06F 21/552; G06F 21/556; G06F 21/566; G06N 20/00; G06N 99/00; G06T 11/206; H04J 3/0661; H04J 3/14; H04L 1/242; H04L 7/10; H04L 9/0866; H04L 9/3239; H04L 9/3242; H04L 41/046; H04L 41/0668; H04L 41/0803; H04L 41/0806; H04L 41/0816; H04L 41/0893; H04L 41/12; H04L 41/16; H04L 41/22; H04L 43/02; H04L 43/026; H04L 43/04; H04L 43/062; H04L 43/08; H04L 43/0805; H04L 43/0811; H04L 43/0829; H04L 43/0841; H04L 43/0858; H04L 43/0864; H04L 43/0876; H04L 43/0882; H04L 43/0888; H04L 43/10; H04L 43/106; H04L 43/12; H04L 43/16; H04L 45/306; H04L 45/38; H04L 45/46; H04L 45/507; H04L 45/66; H04L 45/74; H04L 47/11; H04L 47/20; H04L 47/2441; H04L 47/2483; H04L 47/28; H04L 47/31; H04L 47/32; H04L 61/5007; H04L 63/0227; H04L 63/0263; H04L 63/06; H04L 63/0876; H04L 63/1408; H04L 63/1416; H04L 63/1425; H04L 63/1433; H04L 63/1441; H04L 63/145; H04L 63/1458; H04L 63/1466; H04L 63/16; H04L 63/20; H04L 67/01; H04L 67/10; H04L 67/1001; H04L 67/12; H04L 67/51; H04L 67/75; H04L 69/16; H04L 69/22; H04W 72/54; H04W 84/18; G06F 2009/4557; G06F 2009/45587; G06F 2009/45591; G06F 2009/45595; G06F 2221/033; G06F 2221/2101; G06F 2221/2105; G06F 2221/2111; G06F 2221/2115; G06F 2221/2145; H04L 67/535

(57) ABSTRACT

Systems, methods, and computer-readable media are provided for generating a unique ID for a sensor in a network. Once the sensor is installed on a component of the network, the sensor can send attributes of the sensor to a control server of the network. The attributes of the sensor can include at least one unique identifier of the sensor or the host component of the sensor. The control server can determine a hash value using a one-way hash function and a secret key, send the hash value to the sensor, and designate the hash value as a sensor ID of the sensor. In response to receiving the sensor ID, the sensor can incorporate the sensor ID in subsequent communication messages. Other components of the network can verify the validity of the sensor using a hash of the at least one unique identifier of the sensor and the secret key.

### CROSS-REFERENCE TO RELATED APPLICATIONS

This application is a Continuation of, and claims priority to, U.S. Non-Provisional patent application Ser. No. 18/322,807, entitled “UNIQUE ID GENERATION FOR SENSORS,” filed May 24, 2023, which claims the benefit of, and claims priority to, U.S. Non-Provisional patent application Ser. No. 16/941,426, entitled “UNIQUE ID GENERATION FOR SENSORS,” filed Jul. 28, 2020, which claims the benefit of, and claims priority to, U.S. Non-Provisional patent application Ser. No. 15/163,605, entitled “UNIQUE ID GENERATION FOR SENSORS,” filed May 24, 2016, which claims the benefit of U.S. Provisional Application No. 62/171,899, entitled “SYSTEM FOR MONITORING AND MANAGING DATACENTERS,” filed Jun. 5, 2015, the contents of which are incorporated herein by reference in their entireties.

### TECHNICAL FIELD

The present technology pertains to network analytics, and more specifically to sensors in a network environment.

### BACKGROUND

A modern computer network may comprise a large number of sensors. It is possible that there are one or more identification (ID) collisions between assigned IDs of these sensors. It may be an issue for sensors assigned with conflicted IDs to effectively communicate with other sensors or nodes in the network.

Thus, there is a need to generate and assign unique sensor IDs in a network.

### BRIEF DESCRIPTION OF THE DRAWINGS

In order to describe the manner in which the above-recited and other advantages and features of the disclosure can be obtained, a more particular description of the principles briefly described above will be rendered by reference to specific examples thereof, which are illustrated in the appended drawings. Understanding that these drawings depict only exemplary examples of the disclosure and are not therefore to be considered to be limiting of its scope, the principles herein are described and explained with additional specificity and detail through the use of the accompanying drawings in which:

FIG. 1 illustrates a diagram of an example network environment, according to some examples;

FIG. 2A illustrates a schematic diagram of an example sensor deployment in a virtualized environment, according to some examples;

FIG. 2B illustrates a schematic diagram of an example sensor deployment in an example network device, according to some examples;

FIG. 2C illustrates a schematic diagram of an example reporting system in an example sensor topology, according to some examples;

FIG. 3 illustrates a sequence diagram of an example communication between a sensor and a control server, according to some examples;

FIG. 4 illustrates an example method for generating a unique ID for a sensor in a network, according to some examples;

FIG. 5 illustrates another example method for generating a unique ID for a sensor in a network, according to some examples;

FIG. 6 illustrates an example network device, according to some examples; and

FIGS. 7A and 7B illustrate example system examples.

### DESCRIPTION OF EXAMPLES

Various examples of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

Additional features and advantages of the disclosure will be set forth in the description which follows. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches set forth herein can be used to deploy sensors in a network environment, assign unique identifications (IDs) for the sensors, and analyze data collected from the sensors to monitor and troubleshoot the network. For examples, sensors can be placed at various devices or components in the network to collect flow data and network statistics from various network nodes. Once a sensor is installed on a component (e.g., a virtual machine (VM)) of the network, the sensor can send attributes of the sensor to a control server of the network. The attributes of the sensor can include at least one unique identifier of the sensor or the host component of the sensor. The control server can determine a hash value using a one-way hash function and a secret key, send the hash value to the sensor, and designate the hash value as a sensor ID of the sensor. In response to receiving the sensor ID, the sensor can incorporate the sensor ID in subsequent communication messages. Other components of the network can verify the validity of the sensor using a hash of the at least one unique identifier of the sensor and the secret key.

The at least one unique identifier of the sensor or the host component of the sensor may include, but is not limited to, host name, media access control (MAC) address, and BIOS_UUID etc. The BIOS_UUID is a universally unique identifier (UUID) of a part of the basic input/output system (BIOS) of the host component.

Some examples can migrate a sensor across a network together with a host component of the sensor. For example, the sensor may be migrated together with a VM host. Since the VM host is not changed, host name, the MAC address, and/or BIOS_UUID associated with the sensor remain unchanged. The control server may determine the same hash value as the sensor ID for the sensor.

In some examples, a host component hosting a sensor can be cloned to host the sensor. Since the cloned host component has a different host name, MAC address, and/or BIOS_UUID, the sensor reports a different unique identifier to a controller server. The control server can determine a new hash value using the one-way hash function and the secret key, and then assign the new hash value as a new sensor ID for the sensor.

In some examples, a hash value is a fixed-length hash value using a one-way hash function and various lengths of an input that comprises host name, MAC address, and/or BIOS_UUID. Even a slight change in an input string may cause the hash value to change drastically. For example, if 1 bit of the input string is flipped, at least half of the bits in the hash value may be flipped as a result. It's difficult for either context or length of the input to be recovered. The one-way hash function may include, but is not limited to, hashed message authentication code (HMAC), message digest 2 (MD2), MD4, MD5, secure hash algorithm-1 (SHA-1), SHA-2, and SHA-3. A length of the fixed-length hash value can be at least 64-bit. For example, a length of the fixed-length hash value can be 128-bit using MD2 or 160-bit using SHA-1.

In some examples, a hash value determined has an arbitrary output length using a one-way hash function and various lengths of an input that comprises host name, MAC address, and/or BIOS_UUID. The one-way hash function may include, but is not limited to, a family of sponge functions such as KECCAK.

### DETAILED DESCRIPTION

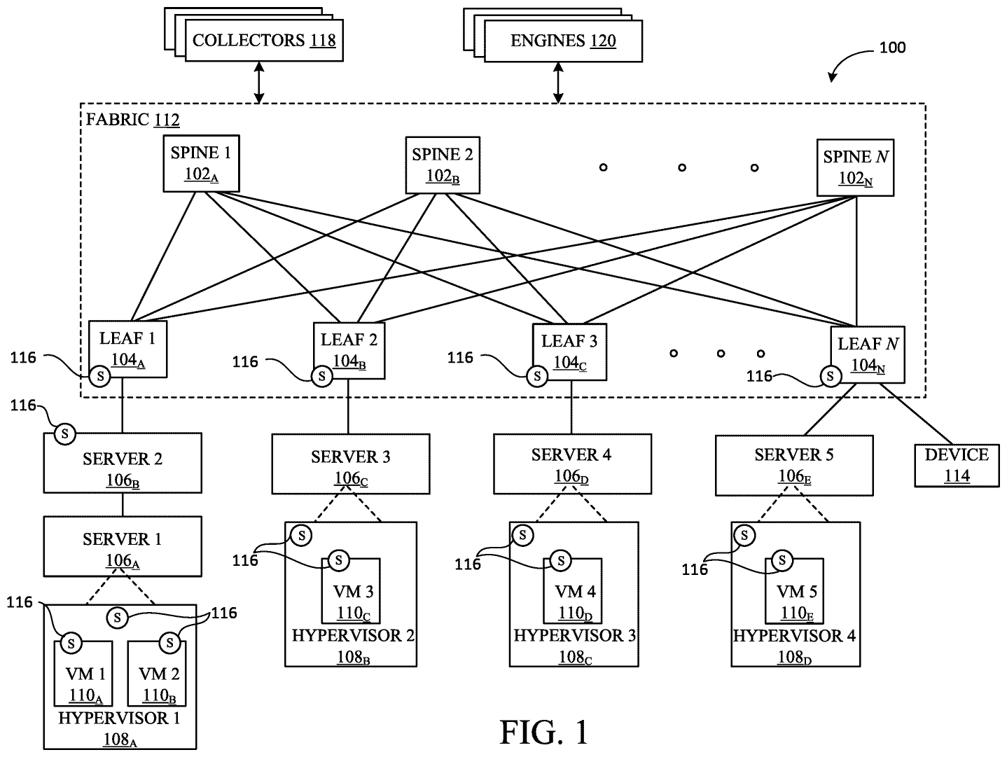

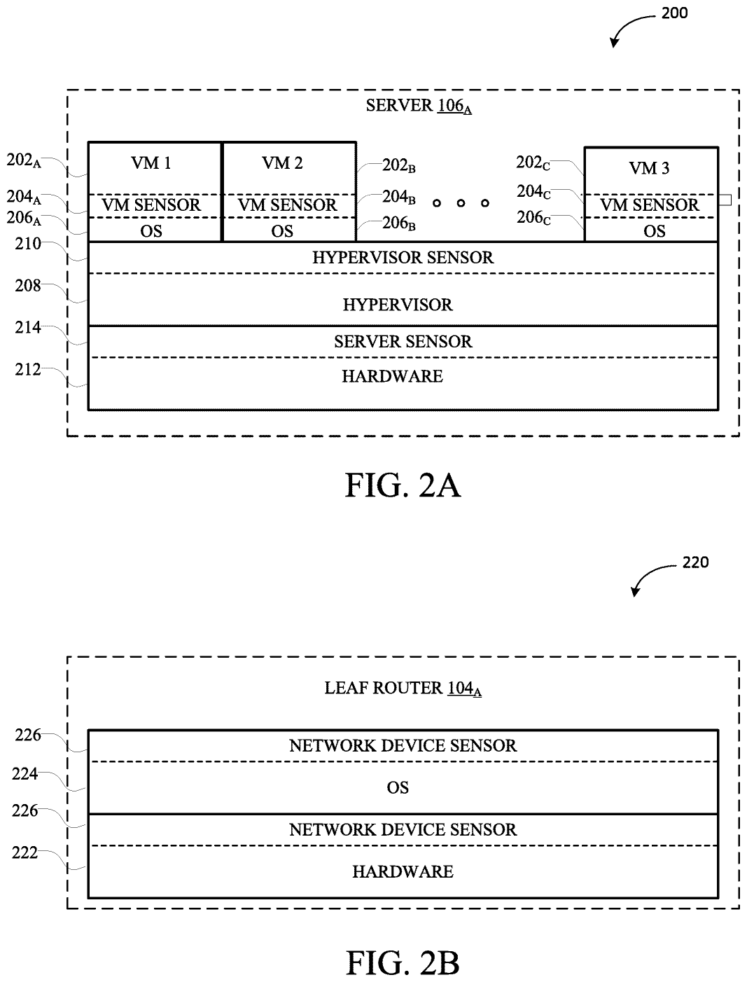

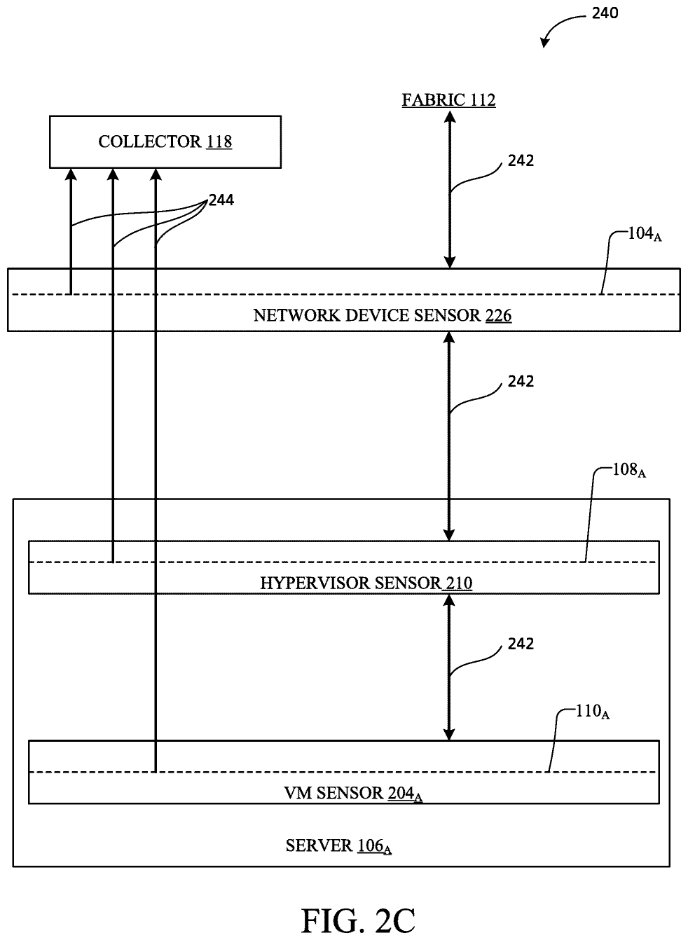

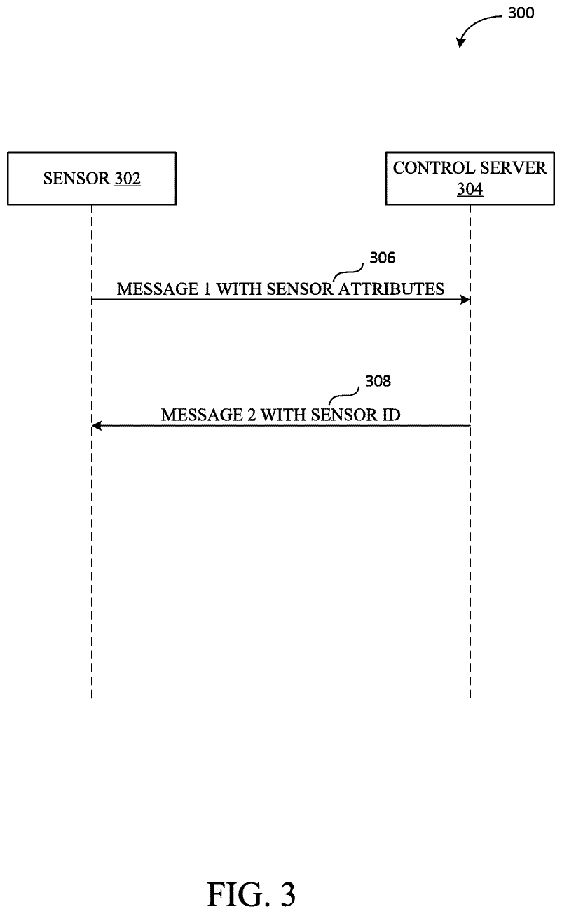

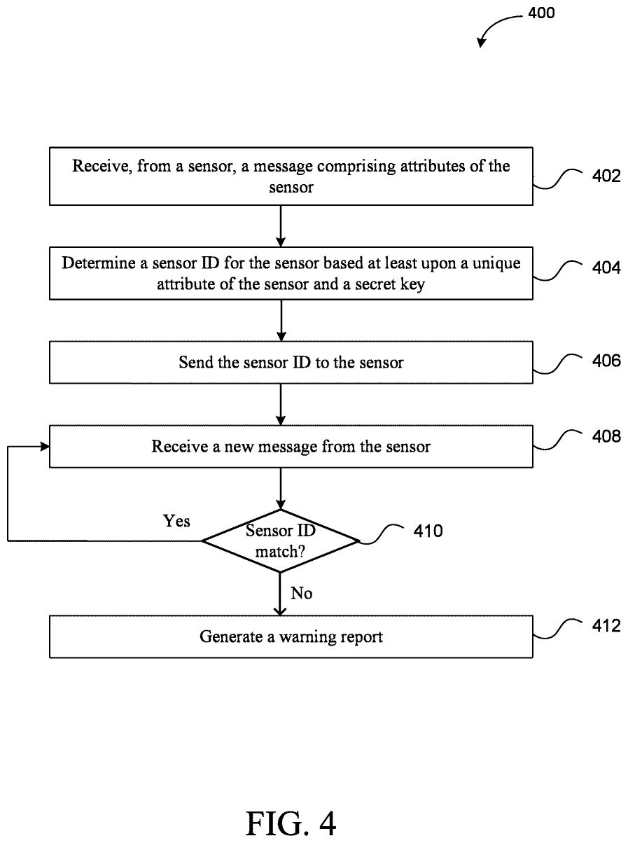

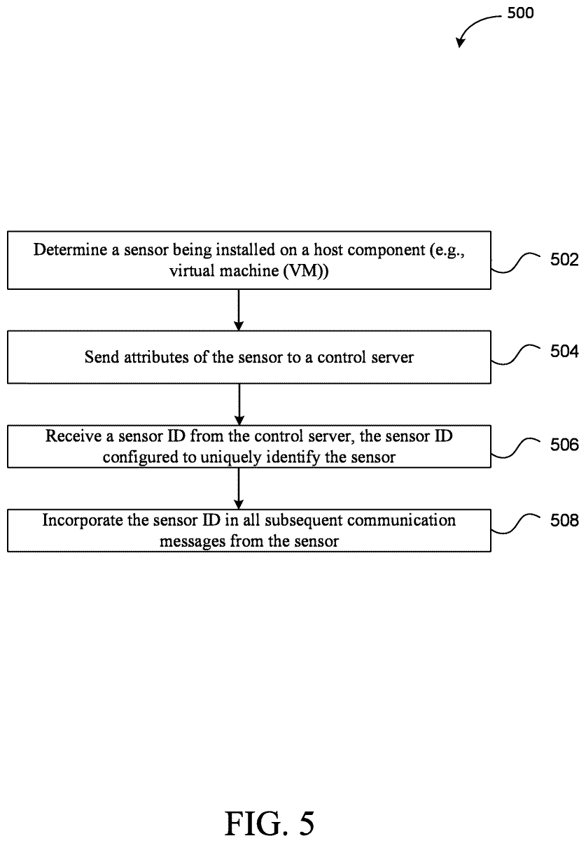

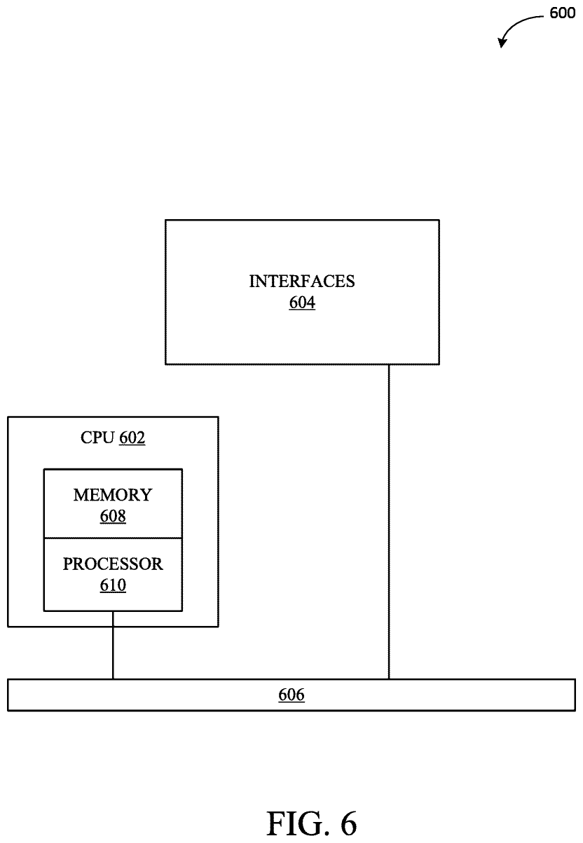

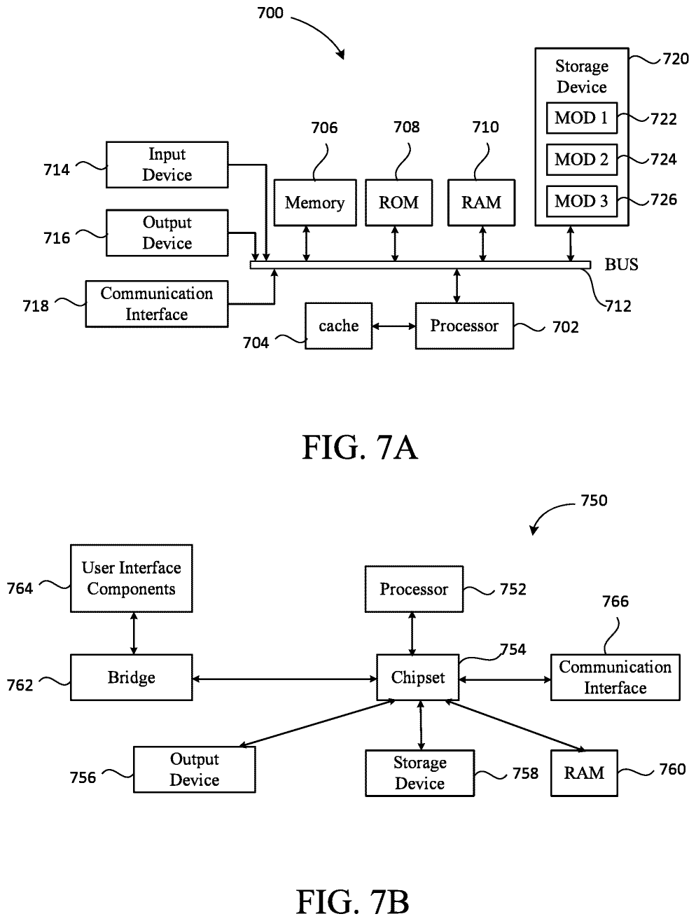

The disclosed technology addresses the need in the art for generating unique sensor IDs in a network. Disclosed are systems, methods, and computer-readable storage media for generating a unique sensor ID for a sensor in a network based on information collected from the sensor. A description of an example network environment, as illustrated in FIG. 1, is first disclosed herein. A discussion of sensors and sensor topologies in virtualized environments, as illustrated in FIGS. 2A-C, will then follow. The discussion follows with a discussion of mechanisms for generating a unique sensor ID, as illustrated in FIG. 3. Then, example methods practiced according to the various examples disclosed herein will be discussed, as illustrated in FIGS. 4-5. The discussion then concludes with a description of example devices, as illustrated in FIGS. 6 and 7A-B. These variations shall be described herein as the various examples are set forth. The disclosure now turns to FIG. 1.

FIG. 1 illustrates a diagram of example network environment 100. Fabric 112 can represent the underlay (i.e., physical network) of network environment 100. Fabric 112 can include spine routers 1-N (102_{A-N}) (collectively “102”) and leaf routers 1-N (104_{A-N}) (collectively “104”). Leaf routers 104 can reside at the edge of fabric 112, and can thus represent the physical network edges. Leaf routers 104 can be, for example, top-of-rack (“ToR”) switches, aggregation switches, gateways, ingress and/or egress switches, provider edge devices, and/or any other type of routing or switching device.

Leaf routers 104 can be responsible for routing and/or bridging tenant or endpoint packets and applying network policies. Spine routers 102 can perform switching and routing within fabric 112. Thus, network connectivity in fabric 112 can flow from spine routers 102 to leaf routers 104, and vice versa.

Leaf routers 104 can provide servers 1-5 (106_{A-E}) (collectively “106”), hypervisors 1-4 (108_{A}-108_{D}) (collectively “108”), and virtual machines (VMs) 1-5 (110_{A}-110_{E}) (collectively “110”) access to fabric 112. For example, leaf routers 104 can encapsulate and decapsulate packets to and from servers 106 in order to enable communications throughout environment 100. Leaf routers 104 can also connect other devices, such as device 114, with fabric 112. Device 114 can be any network-capable device(s) or network(s), such as a firewall, a database, a server, a collector 118 (further described below), an engine 120 (further described below), etc. Leaf routers 104 can also provide any other servers, resources, endpoints, external networks, VMs, services, tenants, or workloads with access to fabric 112.

VMs 110 can be virtual machines hosted by hypervisors 108 running on servers 106. VMs 110 can include workloads running on a guest operating system on a respective server. Hypervisors 108 can provide a layer of software, firmware, and/or hardware that creates and runs the VMs 110. Hypervisors 108 can allow VMs 110 to share hardware resources on servers 106, and the hardware resources on servers 106 to appear as multiple, separate hardware platforms. Moreover, hypervisors 108 and servers 106 can host one or more VMs 110. For example, server 106_{A} and hypervisor 108_{A} can host VMs 110_{A-B}.

In some cases, VMs 110 and/or hypervisors 108 can be migrated to other servers 106. For example, VM 110_{A} can be migrated to server 106_{C} and hypervisor 108_{B}. Servers 106 can similarly be migrated to other locations in network environment 100. For example, a server connected to a specific leaf router can be changed to connect to a different or additional leaf router. In some cases, some or all of servers 106, hypervisors 108, and/or VMs 110 can represent tenant space. Tenant space can include workloads, services, applications, devices, and/or resources that are associated with one or more clients or subscribers. Accordingly, traffic in network environment 100 can be routed based on specific tenant policies, spaces, agreements, configurations, etc. Moreover, addressing can vary between one or more tenants. In some configurations, tenant spaces can be divided into logical segments and/or networks and separated from logical segments and/or networks associated with other tenants.

Any of leaf routers 104, servers 106, hypervisors 108, and VMs 110 can include sensor 116 (also referred to as a “sensor”) configured to capture network data, and report any portion of the captured data to collector 118. Sensors 116 can be processes, agents, modules, drivers, or components deployed on a respective system (e.g., a server, VM, hypervisor, leaf router, etc.), configured to capture network data for the respective system (e.g., data received or transmitted by the respective system), and report some or all of the captured data to collector 118.

For example, a VM sensor can run as a process, kernel module, or kernel driver on the guest operating system installed in a VM and configured to capture data (e.g., network and/or system data) processed (e.g., sent, received, generated, etc.) by the VM. Additionally, a hypervisor sensor can run as a process, kernel module, or kernel driver on the host operating system installed at the hypervisor layer and configured to capture data (e.g., network and/or system data) processed (e.g., sent, received, generated, etc.) by the hypervisor. A server sensor can run as a process, kernel module, or kernel driver on the host operating system of a server and configured to capture data (e.g., network and/or system data) processed (e.g., sent, received, generated, etc.) by the server. And a network device sensor can run as a process or component in a network device, such as leaf routers 104, and configured to capture data (e.g., network and/or system data) processed (e.g., sent, received, generated, etc.) by the network device.

Sensors 116 can be configured to report the observed data and/or metadata about one or more packets, flows, communications, processes, events, and/or activities to collector 118. For example, sensors 116 can capture network data as well as information about the system or host of the sensors 116 (e.g., where the sensors 116 are deployed). Such information can also include, for example, data or metadata of active or previously active processes of the system, operating system user identifiers, metadata of files on the system, system alerts, networking information, etc. Sensors 116 may also analyze all the processes running on the respective VMs, hypervisors, servers, or network devices to determine specifically which process is responsible for a particular flow of network traffic. Similarly, sensors 116 may determine which operating system user(s) is responsible for a given flow. Reported data from sensors 116 can provide details or statistics particular to one or more tenants. For example, reported data from a subset of sensors 116 deployed throughout devices or elements in a tenant space can provide information about the performance, use, quality, events, processes, security status, characteristics, statistics, patterns, conditions, configurations, topology, and/or any other information for the particular tenant space.

Collectors 118 can be one or more devices, modules, workloads and/or processes capable of receiving data from sensors 116. Collectors 118 can thus collect reports and data from sensors 116. Collectors 118 can be deployed anywhere in network environment 100 and/or even on remote networks capable of communicating with network environment 100. For example, one or more collectors can be deployed within fabric 112 or on one or more of the servers 106. One or more collectors can be deployed outside of fabric 112 but connected to one or more leaf routers 104. Collectors 118 can be part of servers 106 and/or separate servers or devices (e.g., device 114). Collectors 118 can also be implemented in a cluster of servers.

Collectors 118 can be configured to collect data from sensors 116. In addition, collectors 118 can be implemented in one or more servers in a distributed fashion. As previously noted, collectors 118 can include one or more collectors. Moreover, each collector can be configured to receive reported data from all sensors 116 or a subset of sensors 116. For example, a collector can be assigned to a subset of sensors 116 so the data received by that specific collector is limited to data from the subset of sensors.

Collectors 118 can be configured to aggregate data from all sensors 116 and/or a subset of sensors 116. Moreover, collectors 118 can be configured to analyze some or all of the data reported by sensors 116. For example, collectors 118 can include analytics engines (e.g., engines 120) for analyzing collected data. Environment 100 can also include separate analytics engines 120 configured to analyze the data reported to collectors 118. For example, engines 120 can be configured to receive collected data from collectors 118 and aggregate the data, analyze the data (individually and/or aggregated), generate reports, identify conditions, compute statistics, visualize reported data, troubleshoot conditions, visualize the network and/or portions of the network (e.g., a tenant space), generate alerts, identify patterns, calculate misconfigurations, identify errors, generate suggestions, generate testing, and/or perform any other analytics functions.

While collectors 118 and engines 120 are shown as separate entities, this is for illustration purposes as other configurations are also contemplated herein. For example, any of collectors 118 and engines 120 can be part of a same or separate entity. Moreover, any of the collector, aggregation, and analytics functions can be implemented by one entity (e.g., collectors 118) or separately implemented by multiple entities (e.g., engine 120 and/or collectors 118).

Each of the sensors 116 can use a respective address (e.g., internet protocol (IP) address, port number, etc.) of their host to send information to collectors 118 and/or any other destination. Collectors 118 may also be associated with their respective addresses such as IP addresses. Moreover, sensors 116 can periodically send information about flows they observe to collectors 118. Sensors 116 can be configured to report each and every flow they observe. Sensors 116 can report a list of flows that were active during a period of time (e.g., between the current time and the time of the last report). The consecutive periods of time of observance can be represented as pre-defined or adjustable time series. The series can be adjusted to a specific level of granularity. Thus, the time periods can be adjusted to control the level of details in statistics and can be customized based on specific requirements, such as security, scalability, storage, etc. The time series information can also be implemented to focus on more important flows or components (e.g., VMs) by varying the time intervals. The communication channel between a sensor and collector 118 can also create a flow in every reporting interval. Thus, the information transmitted or reported by sensors 116 can also include information about the flow created by the communication channel.

FIG. 2A illustrates a schematic diagram of an example sensor deployment 200 in a virtualized environment. Server 106_{A} can execute and host one or more VMs 202_{A-C} (collectively “202”). VMs 202_{A-C} can be similar to VMs 110_{A-E} of FIG. 1. For example, VM 1 (202_{A}) of FIG. 2A can be VM 1 (110_{A}) of FIG. 1, and so forth. VMs 202 can be configured to run workloads (e.g., applications, services, processes, functions, etc.) based on hardware resources 212 on server 106_{A}. VMs 202 can run on guest operating systems 206_{A-C} (collectively “206”) on a virtual operating platform provided by hypervisor 208. Each VM 202 can run a respective guest operating system 206 which can be the same or different as other guest operating systems 206 associated with other VMs 202 on server 106_{A}. Each of guest operating systems 206 can execute one or more processes, which may in turn be programs, applications, modules, drivers, services, widgets, etc. Each of guest operating systems 206 may also be associated with one or more user accounts. For example, many popular operating systems such as LINUX, UNIX, WINDOWS, MAC OS, etc., offer multi-user environments where one or more users can use the system concurrently and share software/hardware resources. One or more users can sign in or log in to their user accounts associated with the operating system and run various workloads. Moreover, each VM 202 can have one or more network addresses, such as an internet protocol (IP) address. VMs 202 can thus communicate with hypervisor 208, server 106_{A}, and/or any remote devices or networks using the one or more network addresses.

Hypervisor 208 (otherwise known as a virtual machine monitor) can be a layer of software, firmware, and/or hardware that creates and runs VMs 202. Guest operating systems 206 running on VMs 202 can share virtualized hardware resources created by hypervisor 208. The virtualized hardware resources can provide the illusion of separate hardware components. Moreover, the virtualized hardware resources can perform as physical hardware components (e.g., memory, storage, processor, network interface, etc.), and can be driven by hardware resources 212 on server 106_{A}. Hypervisor 208 can have one or more network addresses, such as an internet protocol (IP) address, to communicate with other devices, components, or networks. For example, hypervisor 208 can have a dedicated IP address which it can use to communicate with VMs 202, server 106_{A}, and/or any remote devices or networks.

Hardware resources 212 of server 106_{A} can provide the underlying physical hardware that drives operations and functionalities provided by server 106_{A}, hypervisor 208, and VMs 202. Hardware resources 212 can include, for example, one or more memory resources, one or more storage resources, one or more communication interfaces, one or more processors, one or more circuit boards, one or more buses, one or more extension cards, one or more power supplies, one or more antennas, one or more peripheral components, etc. Additional examples of hardware resources are described below with reference to FIGS. 6 and 7A-B.

Server 106_{A} can also include one or more host operating systems (not shown). The number of host operating system can vary by configuration. For example, some configurations can include a dual boot configuration that allows server 106_{A} to boot into one of multiple host operating systems. In other configurations, server 106_{A} may run a single host operating system. Host operating systems can run on hardware resources 212. In some cases, hypervisor 208 can run on, or utilize, a host operating system on server 106_{A}. Each of the host operating systems can execute one or more processes, which may be programs, applications, modules, drivers, services, widgets, etc. Each of the host operating systems may also be associated with one or more OS user accounts.

Server 106_{A} can also have one or more network addresses, such as an internet protocol (IP) address, to communicate with other devices, components, or networks. For example, server 106_{A} can have an IP address assigned to a communications interface from hardware resources 212, which it can use to communicate with VMs 202, hypervisor 208, leaf router 104_{A} in FIG. 1, collectors 118 in FIG. 1, and/or any remote devices or networks.

VM sensors 204_{A-C} (collectively “204”) can be deployed on one or more of VMs 202. VM sensors 204 can be data and packet inspection agents or sensors deployed on VMs 202 to capture packets, flows, processes, events, traffic, and/or any data flowing into, out of, or through VMs 202. VM sensors 204 can be configured to export or report any data collected or captured by the sensors 204 to a remote entity, such as collectors 118, for example. VM sensors 204 can communicate or report such data using a network address of the respective VMs 202 (e.g., VM IP address).

VM sensors 204 can capture and report any traffic (e.g., packets, flows, etc.) sent, received, generated, and/or processed by VMs 202. For example, sensors 204 can report every packet or flow of communication sent and received by VMs 202. Such communication channel between sensors 204 and collectors 108 creates a flow in every monitoring period or interval and the flow generated by sensors 204 may be denoted as a control flow. Moreover, any communication sent or received by VMs 202, including data reported from sensors 204, can create a network flow. VM sensors 204 can report such flows in the form of a control flow to a remote device, such as collectors 118 illustrated in FIG. 1. VM sensors 204 can report each flow separately or aggregated with other flows. When reporting a flow via a control flow, VM sensors 204 can include a sensor identifier that identifies sensors 204 as reporting the associated flow. VM sensors 204 can also include in the control flow a flow identifier, an IP address, a timestamp, metadata, a process ID, an OS username associated with the process ID, and any other information, as further described below. In addition, sensors 204 can append the process and user information (i.e., which process and/or user is associated with a particular flow) to the control flow. The additional information as identified above can be applied to the control flow as labels. Alternatively, the additional information can be included as part of a header, a trailer, or a payload.

VM sensors 204 can also report multiple flows as a set of flows. When reporting a set of flows, VM sensors 204 can include a flow identifier for the set of flows and/or a flow identifier for each flow in the set of flows. VM sensors 204 can also include one or more timestamps and other information as previously explained.

VM sensors 204 can run as a process, kernel module, or kernel driver on guest operating systems 206 of VMs 202. VM sensors 204 can thus monitor any traffic sent, received, or processed by VMs 202, any processes running on guest operating systems 206, any users and user activities on guest operating system 206, any workloads on VMs 202, etc.

Hypervisor sensor 210 can be deployed on hypervisor 208. Hypervisor sensor 210 can be a data inspection agent or a sensor deployed on hypervisor 208 to capture traffic (e.g., packets, flows, etc.) and/or data flowing through hypervisor 208. Hypervisor sensor 210 can be configured to export or report any data collected or captured by hypervisor sensor 210 to a remote entity, such as collectors 118, for example. Hypervisor sensor 210 can communicate or report such data using a network address of hypervisor 208, such as an IP address of hypervisor 208.

Because hypervisor 208 can see traffic and data originating from VMs 202, hypervisor sensor 210 can also capture and report any data (e.g., traffic data) associated with VMs 202. For example, hypervisor sensor 210 can report every packet or flow of communication sent or received by VMs 202 and/or VM sensors 204. Moreover, any communication sent or received by hypervisor 208, including data reported from hypervisor sensor 210, can create a network flow. Hypervisor sensor 210 can report such flows in the form of a control flow to a remote device, such as collectors 118 illustrated in FIG. 1. Hypervisor sensor 210 can report each flow separately and/or in combination with other flows or data. When reporting a flow, hypervisor sensor 210 can include a sensor identifier that identifies hypervisor sensor 210 as reporting the flow. Hypervisor sensor 210 can also include in the control flow a flow identifier, an IP address, a timestamp, metadata, a process ID, and any other information, as explained below. In addition, sensors 210 can append the process and user information (i.e., which process and/or user is associated with a particular flow) to the control flow. The additional information as identified above can be applied to the control flow as labels. Alternatively, the additional information can be included as part of a header, a trailer, or a payload.

Hypervisor sensor 210 can also report multiple flows as a set of flows. When reporting a set of flows, hypervisor sensor 210 can include a flow identifier for the set of flows and/or a flow identifier for each flow in the set of flows. Hypervisor sensor 210 can also include one or more timestamps and other information as previously explained, such as process and user information.

As previously explained, any communication captured or reported by VM sensors 204 can flow through hypervisor 208. Thus, hypervisor sensor 210 can observe and capture any flows or packets reported by VM sensors 204, including any control flows. Accordingly, hypervisor sensor 210 can also report any packets or flows reported by VM sensors 204 and any control flows generated by VM sensors 204. For example, VM sensor 204_{A} on VM 1 (202_{A}) captures flow 1 (“F1”) and reports F1 to collector 118 on FIG. 1. Hypervisor sensor 210 on hypervisor 208 can also see and capture F1, as F1 would traverse hypervisor 208 when being sent or received by VM 1 (202_{A}). Accordingly, hypervisor sensor 210 on hypervisor 208 can also report F1 to collector 118. Thus, collector 118 can receive a report of F1 from VM sensor 204_{A} on VM 1 (202_{A}) and another report of F1 from hypervisor sensor 210 on hypervisor 208.

When reporting F1, hypervisor sensor 210 can report F1 as a message or report that is separate from the message or report of F1 transmitted by VM sensor 204_{A} on VM 1 (202_{A}). However, hypervisor sensor 210 can also, or otherwise, report F1 as a message or report that includes or appends the message or report of F1 transmitted by VM sensor 204_{A} on VM 1 (202_{A}). In other words, hypervisor sensor 210 can report F1 as a separate message or report from VM sensor 204_{A}'s message or report of F1, and/or a same message or report that includes both a report of F1 by hypervisor sensor 210 and the report of F1 by VM sensor 204_{A} at VM 1 (202_{A}). In this way, VM sensors 204 at VMs 202 can report packets or flows received or sent by VMs 202, and hypervisor sensor 210 at hypervisor 208 can report packets or flows received or sent by hypervisor 208, including any flows or packets received or sent by VMs 202 and/or reported by VM sensors 204.

Hypervisor sensor 210 can run as a process, kernel module, or kernel driver on the host operating system associated with hypervisor 208. Hypervisor sensor 210 can thus monitor any traffic sent and received by hypervisor 208, any processes associated with hypervisor 208, etc.

Server 106_{A} can also have server sensor 214 running on it. Server sensor 214 can be a data inspection agent or sensor deployed on server 106_{A} to capture data (e.g., packets, flows, traffic data, etc.) on server 106_{A}. Server sensor 214 can be configured to export or report any data collected or captured by server sensor 214 to a remote entity, such as collector 118, for example. Server sensor 214 can communicate or report such data using a network address of server 106_{A}, such as an IP address of server 106_{A}.

Server sensor 214 can capture and report any packet or flow of communication associated with server 106_{A}. For example, sensor 216 can report every packet or flow of communication sent or received by one or more communication interfaces of server 106_{A}. Moreover, any communication sent or received by server 106_{A}, including data reported from sensors 204 and 210, can create a network flow associated with server 106_{A}. Server sensor 214 can report such flows in the form of a control flow to a remote device, such as collector 118 illustrated in FIG. 1. Server sensor 214 can report each flow separately or in combination. When reporting a flow, server sensor 214 can include a sensor identifier that identifies server sensor 214 as reporting the associated flow. Server sensor 214 can also include in the control flow a flow identifier, an IP address, a timestamp, metadata, a process ID, and any other information. In addition, sensor 214 can append the process and user information (i.e., which process and/or user is associated with a particular flow) to the control flow. The additional information as identified above can be applied to the control flow as labels. Alternatively, the additional information can be included as part of a header, a trailer, or a payload.

Server sensor 214 can also report multiple flows as a set of flows. When reporting a set of flows, server sensor 214 can include a flow identifier for the set of flows and/or a flow identifier for each flow in the set of flows. Server sensor 214 can also include one or more timestamps and other information as previously explained.

Any communications captured or reported by sensors 204 and 210 can flow through server 106_{A}. Thus, server sensor 214 can observe or capture any flows or packets reported by sensors 204 and 210. In other words, network data observed by sensors 204 and 210 inside VMs 202 and hypervisor 208 can be a subset of the data observed by server sensor 214 on server 106_{A}. Accordingly, server sensor 214 can report any packets or flows reported by sensors 204 and 210 and any control flows generated by sensors 204 and 210. For example, sensor 204_{A} on VM 1 (202_{A}) captures flow 1 (F1) and reports F1 to collector 118 as illustrated on FIG. 1. sensor 210 on hypervisor 208 can also observe and capture F1, as F1 would traverse hypervisor 208 when being sent or received by VM 1 (202_{A}). In addition, sensor 214 on server 106_{A} can also see and capture F1, as F1 would traverse server 106_{A} when being sent or received by VM 1 (202_{A}) and hypervisor 208. Accordingly, sensor 214 can also report F1 to collector 118. Thus, collector 118 can receive a report (i.e., control flow) regarding F1 from sensor 204_{A} on VM 1 (202_{A}), sensor 210 on hypervisor 208, and sensor 214 on server 106_{A}.

When reporting F1, server sensor 214 can report F1 as a message or report that is separate from any messages or reports of F1 transmitted by sensor 204_{A} on VM 1 (202_{A}) or sensor 210 on hypervisor 208. However, server sensor 214 can also, or otherwise, report F1 as a message or report that includes or appends the messages or reports or metadata of F1 transmitted by sensor 204_{A} on VM 1 (202_{A}) and sensor 210 on hypervisor 208. In other words, server sensor 214 can report F1 as a separate message or report from the messages or reports of F1 from sensor 204_{A} and sensor 210, and/or a same message or report that includes a report of F1 by sensor 204_{A}, sensor 210, and sensor 214. In this way, sensors 204 at VMs 202 can report packets or flows received or sent by VMs 202, sensor 210 at hypervisor 208 can report packets or flows received or sent by hypervisor 208, including any flows or packets received or sent by VMs 202 and reported by sensors 204, and sensor 214 at server 106_{A} can report packets or flows received or sent by server 106_{A}, including any flows or packets received or sent by VMs 202 and reported by sensors 204, and any flows or packets received or sent by hypervisor 208 and reported by sensor 210.

Server sensor 214 can run as a process, kernel module, or kernel driver on the host operating system or a hardware component of server 106_{A}. Server sensor 214 can thus monitor any traffic sent and received by server 106_{A}, any processes associated with server 106_{A}, etc.

In addition to network data, sensors 204, 210, and 214 can capture additional information about the system or environment in which they reside. For example, sensors 204, 210, and 214 can capture data or metadata of active or previously active processes of their respective system or environment, operating system user identifiers, metadata of files on their respective system or environment, timestamps, network addressing information, flow identifiers, sensor identifiers, etc. Moreover, sensors 204, 210, 214 are not specific to any operating system environment, hypervisor environment, network environment, or hardware environment. Thus, sensors 204, 210, and 214 can operate in any environment.

As previously explained, sensors 204, 210, and 214 can send information about the network traffic they observe. This information can be sent to one or more remote devices, such as one or more servers, collectors, engines, etc. Each sensor can be configured to send respective information using a network address, such as an IP address, and any other communication details, such as port number, to one or more destination addresses or locations. Sensors 204, 210, and 214 can send metadata about one or more flows, packets, communications, processes, events, etc.

Sensors 204, 210, and 214 can periodically report information about each flow or packet they observe. The information reported can contain a list of flows or packets that were active during a period of time (e.g., between the current time and the time at which the last information was reported). The communication channel between the sensor and the destination can create a flow in every interval. For example, the communication channel between sensor 214 and collector 118 can create a control flow. Thus, the information reported by a sensor can also contain information about this control flow. For example, the information reported by sensor 214 to collector 118 can include a list of flows or packets that were active at hypervisor 208 during a period of time, as well as information about the communication channel between sensor 210 and collector 118 used to report the information by sensor 210.

FIG. 2B illustrates a schematic diagram of example sensor deployment 220 in an example network device. The network device is described as leaf router 104_{A}, as illustrated in FIG. 1. However, this is for explanation purposes. The network device can be any other network device, such as any other switch, router, etc.

In this example, leaf router 104_{A} can include network resources 222, such as memory, storage, communication, processing, input, output, and other types of resources. Leaf router 104_{A} can also include operating system environment 224. The operating system environment 224 can include any operating system, such as a network operating system, embedded operating system, etc. Operating system environment 224 can include processes, functions, and applications for performing networking, routing, switching, forwarding, policy implementation, messaging, monitoring, and other types of operations.

Leaf router 104_{A} can also include sensor 226. Sensor 226 can be an agent or sensor configured to capture network data, such as flows or packets, sent received, or processed by leaf router 104_{A}. Sensor 226 can also be configured to capture other information, such as processes, statistics, users, alerts, status information, device information, etc. Moreover, sensor 226 can be configured to report captured data to a remote device or network, such as collector 118 shown in FIG. 1, for example. Sensor 226 can report information using one or more network addresses associated with leaf router 104_{A} or collector 118. For example, sensor 226 can be configured to report information using an IP assigned to an active communications interface on leaf router 104_{A}.

Leaf router 104_{A} can be configured to route traffic to and from other devices or networks, such as server 106_{A}. Accordingly, sensor 226 can also report data reported by other sensors on other devices. For example, leaf router 104_{A} can be configured to route traffic sent and received by server 106_{A} to other devices. Thus, data reported from sensors deployed on server 106_{A}, such as VM and hypervisor sensors on server 106_{A}, would also be observed by sensor 226 and can thus be reported by sensor 226 as data observed at leaf router 104_{A}. Such report can be a control flow generated by sensor 226. Data reported by the VM and hypervisor sensors on server 106_{A} can therefore be a subset of the data reported by sensor 226.

Sensor 226 can run as a process or component (e.g., firmware, module, hardware device, etc.) in leaf router 104_{A}. Moreover, sensor 226 can be installed on leaf router 104_{A} as a software or firmware agent. In some configurations, leaf router 104_{A} itself can act as sensor 226. Moreover, sensor 226 can run within operating system 224 and/or separate from operating system 224.

FIG. 2C illustrates a schematic diagram of example reporting system 240 in an example sensor topology. Leaf router 104_{A} can route packets or traffic 242 between fabric 112 and server 106_{A}, hypervisor 108_{A}, and VM 110_{A}. Packets or traffic 242 between VM 110_{A} and leaf router 104_{A} can flow through hypervisor 108_{A} and server 106_{A}. Packets or traffic 242 between hypervisor 108_{A} and leaf router 104_{A} can flow through server 106_{A}. Finally, packets or traffic 242 between server 106_{A} and leaf router 104_{A} can flow directly to leaf router 104_{A}. However, in some cases, packets or traffic 242 between server 106_{A} and leaf router 104_{A} can flow through one or more intervening devices or networks, such as a switch or a firewall.

Moreover, VM sensor 204_{A} at VM 110_{A}, hypervisor sensor 210 at hypervisor 108_{A}, network device sensor 226 at leaf router 104_{A}, and any server sensor at server 106_{A} (e.g., sensor running on host environment of server 106_{A}) can send reports 244 (also referred to as control flows) to collector 118 based on the packets or traffic 242 captured at each respective sensor. Reports 244 from VM sensor 204_{A} to collector 118 can flow through VM 110_{A}, hypervisor 108_{A}, server 106_{A}, and leaf router 104_{A}. Reports 244 from hypervisor sensor 210 to collector 118 can flow through hypervisor 108_{A}, server 106_{A}, and leaf router 104_{A}. Reports 244 from any other server sensor at server 106_{A} to collector 118 can flow through server 106_{A} and leaf router 104_{A}. Finally, reports 244 from network device sensor 226 to collector 118 can flow through leaf router 104_{A}. Although reports 244 are depicted as being routed separately from traffic 242 in FIG. 2C, one of ordinary skill in the art will understand that reports 244 and traffic 242 can be transmitted through the same communication channel(s).

Reports 244 can include any portion of packets or traffic 242 captured at the respective sensors. Reports 244 can also include other information, such as timestamps, process information, sensor identifiers, flow identifiers, flow statistics, notifications, logs, user information, system information, addresses, ports, protocols, etc. Some or all of this information can be appended to reports 244 as one or more labels, metadata, or as part of the packet(s)' header, trailer, or payload. For example, if a user opens a browser on VM 110_{A} and navigates to examplewebsite.com, VM sensor 204_{A} of VM 110_{A} can determine which user (i.e., operating system user) of VM 110_{A} (e.g., username “johndoe85”) and which process being executed on the operating system of VM 110_{A} (e.g., “chrome.exe”) were responsible for the particular network flow to and from examplewebsite.com. Once such information is determined, the information can be included in report 244 as labels for example, and report 244 can be transmitted from VM sensor 204_{A} to collector 118. Such additional information can help system 240 to gain insight into flow information at the process and user level, for instance. This information can be used for security, optimization, and determining structures and dependencies within system 240. Moreover, reports 244 can be transmitted to collector 118 periodically as new packets or traffic 242 are captured by a sensor. Further, each sensor can send a single report or multiple reports to collector 118. For example, each of the sensors 116 can be configured to send a report to collector 118 for every flow, packet, message, communication, or network data received, transmitted, and/or generated by its respective host (e.g., VM 110_{A}, hypervisor 108_{A}, server 106_{A}, and leaf router 104_{A}). As such, collector 118 can receive a report of a same packet from multiple sensors.

For example, a packet received by VM 110_{A} from fabric 112 can be captured and reported by VM sensor 204_{A}. Since the packet received by VM 110_{A} will also flow through leaf router 104_{A} and hypervisor 108_{A}, it can also be captured and reported by hypervisor sensor 210 and network device sensor 226. Thus, for a packet received by VM 110_{A} from fabric 112, collector 118 can receive a report of the packet from VM sensor 204_{A}, hypervisor sensor 210, and network device sensor 226.

Similarly, a packet sent by VM 110_{A} to fabric 112 can be captured and reported by VM sensor 204_{A}. Since the packet sent by VM 110_{A} will also flow through leaf router 104_{A} and hypervisor 108_{A}, it can also be captured and reported by hypervisor sensor 210 and network device sensor 226. Thus, for a packet sent by VM 110_{A} to fabric 112, collector 118 can receive a report of the packet from VM sensor 204_{A}, hypervisor sensor 210, and network device sensor 226.

On the other hand, a packet originating at, or destined to, hypervisor 108_{A}, can be captured and reported by hypervisor sensor 210 and network device sensor 226, but not VM sensor 204_{A}, as such packet may not flow through VM 110_{A}. Moreover, a packet originating at, or destined to, leaf router 104_{A}, will be captured and reported by network device sensor 226, but not VM sensor 204_{A}, hypervisor sensor 210, or any other sensor on server 106_{A}, as such packet may not flow through VM 110_{A}, hypervisor 108_{A}, or server 106_{A}.

Each of the sensors 204_{A}, 210, 226 can include a respective unique sensor identifier on each of reports 244 it sends to collector 118, to allow collector 118 to determine which sensor sent the report. Reports 244 can be used to analyze network and/or system data and conditions for troubleshooting, security, visualization, configuration, planning, and management. Sensor identifiers in reports 244 can also be used to determine which sensors reported what flows. This information can then be used to determine sensor placement and topology, as further described below, as well as mapping individual flows to processes and users. Such additional insights gained can be useful for analyzing the data in reports 244, as well as troubleshooting, security, visualization, configuration, planning, and management.

FIG. 3 illustrates a sequence diagram of an example communication 300 between a sensor and a control server in a network. In this example, the communication 300 between a sensor 302 and a control server 304, one or more messages such as messages 1-2 (306-308) may be exchanged between the sensor 302 and the control server 304. After the sensor 302 is installed on a host component (e.g., a host VM), the sensor 302 can send attributes of the sensor 302 to the control server 304 via a message 1 (306). The message 1 (306) includes at least one unique identifier of the sensor 302 or the host component of the sensor 302.

In response to receiving the attributes of the sensor 302, the control server 304 can determine a hash value, using a one-way hash function and a secret key, based upon the attributes of the sensor 302. In some examples, the hash value is a fixed length hash value that is independent from the length of an input string to generate the hash value. The one-way hash function includes, HMAC, MD2, MD4, MD5, SHA-1, SHA-2, and SHA-3.

The control server 304 can then send the hash value to the sensor 302 and designate the hash value as a sensor ID of the sensor. In response to receiving the sensor ID, the sensor 302 incorporates the sensor ID in all subsequent communication messages. Other components, nodes or sensors of the network can receive communication message(s) from the sensor 302, and further verify the validity of the sensor 302. For example, a backend server of the network can determine a hash value based upon attributes of the sensor 302 using the one-way hash function and the secret key. If the hash value is inconsistent with the sensor ID that is incorporated in the communication message(s) of the sensor 302, the backend server can determine that the sensor 302 may be under an attack and can generate a warning report.

As one of skill in the art will appreciate, some of all of the various methods and rules—timing, degree, magnitude, graph consistency, historical data, hash function, etc.—as described in this disclosure can be used in combination. Different weights can also be assigned to different rules and methods depending on the accuracy, margin of error, etc. of each rule or method.

Having disclosed some basic system components and concepts, the disclosure now turns to the exemplary method examples shown in FIGS. 4-5. For the sake of clarity, the methods are described in terms of system 100, as shown in FIG. 1, configured to practice the method. However, the example methods can be practiced by any software or hardware components, devices, etc. heretofore disclosed, such as system 200 of FIG. 2A, system 220 of FIG. 2B, system 600 of FIG. 6, system 700 of FIG. 7A, system 750 of FIG. 7B, etc. The steps outlined herein are exemplary and can be implemented in any combination thereof in any order, including combinations that exclude, add, or modify certain steps.

FIG. 4 illustrates an example method 400 for generating a unique ID for a sensor in a network, according to some examples. It should be understood that the exemplary method 400 is presented solely for illustrative purposes and that in other methods in accordance with the present technology can include additional, fewer, or alternative steps performed in similar or alternative orders, or in parallel. The system 100 can receive a message from the sensor, at step 402. The message comprises attributes of the sensor that includes at least one unique identifier of the sensor or the host component of the sensor. The host component can be an endpoint, a terminal, a server, a virtual machine, a hypervisor, a switch, a gateway, etc. The at least one unique identifier of the sensor or the host component of the sensor may include host name, MAC address, and BIOS_UUID etc.

Based on the at least one unique identifier of the sensor or the host component of the sensor, the system 100 can determine a sensor ID for the sensor, at step 404. For example, the system 100 can determine a hash value using a one-way hash function and a secret key and designate the hash value as the sensor ID for the sensor. The one-way hash function may include HMAC, MD2, MD4, MD5, SHA-1, SHA-2, SHA-3, and KECCAK.

The system 100 can then send the sensor ID to the sensor, at step 406, and cause the sensor to incorporate the sensor ID and attributes of the sensor (e.g., the at least one unique identifier of the sensor or the host component of the sensor) in all subsequent communication messages. The system 100 or a component may receive or collect the subsequent communication messages from the sensor, at step 408. The system 100 can further determine a hash value based upon received attributes of the sensor using the one-way hash function and the secret key, and compare the hash value with the sensor ID incorporated in the subsequent communication message(s), at step 410.

In response to determining that the hash value is consistent with the sensor ID, the method 400 returns to step 408 to receive or monitor additional communication message(s) from the sensor. In response to determining that the hash value is inconsistent with the sensor ID, the system 100 may generate a warning report, at step 412, to indicate that the system 100 or the senor may be under an attack.

FIG. 5 illustrates another example method 500 for generating a unique ID for a sensor in a network, according to some examples. In this example, the system 100 can determine that a sensor is installed on a host component, at step 502, and then cause the sensor to send attribute of the sensor to a control server of the network, at step 504. The attributes includes at least one unique identifier of the sensor or the host component of the sensor that comprises host name, MAC address, and BIOS_UUID of the host component.

The system 100 can further cause the control server to determine a sensor ID for the sensor. The sensor ID can be used to uniquely identify the sensor in the network. The sensor ID is a hash value determined using a one-way hash function, a secret key, and the at least one unique identifier of the sensor or the host component of the sensor.

The sensor receives the sensor ID from the control server, at step 506. The system 100 can further cause the sensor to incorporate the sensor ID and the at least one unique identifier in all subsequent communication messages, at step 508. The system 100 can verify the sensor based upon the sensor ID incorporated in the subsequent communication message(s) from the sensor.

### Example Devices

FIG. 6 illustrates an example network device 600 according to some examples. Network device 600 includes a master central processing unit (CPU) 602, interfaces 604, and a bus 606 (e.g., a PCI bus). When acting under the control of appropriate software or firmware, the CPU 602 is responsible for executing packet management, error detection, and/or routing functions. The CPU 602 preferably accomplishes all these functions under the control of software including an operating system and any appropriate applications software. CPU 602 may include one or more processors 610 such as a processor from the Motorola family of microprocessors or the MIPS family of microprocessors. In an alternative example, processor 610 is specially designed hardware for controlling the operations of router. In a specific example, a memory 608 (such as non-volatile RAM and/or ROM) also forms part of CPU 602. However, there are many different ways in which memory could be coupled to the system.

The interfaces 604 are typically provided as interface cards (sometimes referred to as “line cards”). Generally, they control the sending and receiving of data packets over the network and sometimes support other peripherals used with the router. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 602 to efficiently perform routing computations, network diagnostics, security functions, etc.

Although the system shown in FIG. 6 is one specific network device of the present invention, it is by no means the only network device architecture on which the present invention can be implemented. For example, an architecture having a single processor that handles communications as well as routing computations, etc. is often used. Further, other types of interfaces and media could also be used with the router.

Regardless of the network device's configuration, it may employ one or more memories or memory modules (including memory 608) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc.

FIG. 7A and FIG. 7B illustrate example system examples. The more appropriate example will be apparent to those of ordinary skill in the art when practicing the present technology. Persons of ordinary skill in the art will also readily appreciate that other system examples are possible.

FIG. 7A illustrates a conventional system bus computing system architecture 700 wherein the components of the system are in electrical communication with each other using a bus 712. Exemplary system 700 includes a processing unit (CPU or processor) 702 and a system bus 712 that couples various system components including the system memory 706, such as read only memory (ROM) 708 and random access memory (RAM) 710, to the processor 702. The system 700 can include a cache of high-speed memory connected directly with, in close proximity to, or integrated as part of the processor 702. The system 700 can copy data from the memory 706 and/or the storage device 720 to the cache 704 for quick access by the processor 702. In this way, the cache can provide a performance boost that avoids processor 702 delays while waiting for data. These and other modules can control or be configured to control the processor 702 to perform various actions. Other system memory 706 may be available for use as well. The memory 706 can include multiple different types of memory with different performance characteristics. The processor 702 can include any general purpose processor and a hardware module or software module, such as module 1 (722), module 2 (724), and module 3 (726) stored in storage device 720, configured to control the processor 702 as well as a special-purpose processor where software instructions are incorporated into the actual processor design. The processor 702 may essentially be a completely self-contained computing system, containing multiple cores or processors, a bus, memory controller, cache, etc. A multi-core processor may be symmetric or asymmetric.

To enable user interaction with the system 700, an input device 714 can represent any number of input mechanisms, such as a microphone for speech, a touch-sensitive screen for gesture or graphical input, keyboard, mouse, motion input, speech and so forth. An output device 716 can also be one or more of a number of output mechanisms known to those of skill in the art. In some instances, multimodal systems can enable a user to provide multiple types of input to communicate with the system 700. The communications interface 718 can generally govern and manage the user input and system output. There is no restriction on operating on any particular hardware arrangement and therefore the basic features here may easily be substituted for improved hardware or firmware arrangements as they are developed.

Storage device 720 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 710, read only memory (ROM) 708, and hybrids thereof.

The storage device 720 can include software modules 722, 724, 726 for controlling the processor 702. Other hardware or software modules are contemplated. The storage device 720 can be connected to the system bus 712. In one aspect, a hardware module that performs a particular function can include the software component stored in a computer-readable medium in connection with the necessary hardware components, such as the processor 702, bus 712, display 716, and so forth, to carry out the function.

FIG. 7B illustrates an example computer system 750 having a chipset architecture that can be used in executing the described method and generating and displaying a graphical user interface (GUI). Computer system 750 is an example of computer hardware, software, and firmware that can be used to implement the disclosed technology. System 750 can include a processor 752, representative of any number of physically and/or logically distinct resources capable of executing software, firmware, and hardware configured to perform identified computations. Processor 752 can communicate with a chipset 754 that can control input to and output from processor 752. In this example, chipset 754 outputs information to output device 756, such as a display, and can read and write information to storage device 758, which can include magnetic media, and solid state media, for example. Chipset 754 can also read data from and write data to RAM 760. A bridge 762 for interfacing with a variety of user interface components 764 can be provided for interfacing with chipset 754. Such user interface components 764 can include a keyboard, a microphone, touch detection and processing circuitry, a pointing device, such as a mouse, and so on. In general, inputs to system 750 can come from any of a variety of sources, machine generated and/or human generated.

Chipset 754 can also interface with one or more communication interfaces 766 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 752 analyzing data stored in storage 758 or 760. Further, the machine can receive inputs from a user via user interface components 764 and execute appropriate functions, such as browsing functions by interpreting these inputs using processor 752.

It can be appreciated that example systems 700 and 750 can have more than one processor 702 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some examples the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

It should be understood that features or configurations herein with reference to one embodiment or example can be implemented in, or combined with, other examples or examples herein. That is, terms such as “embodiment”, “variation”, “aspect”, “example”, “configuration”, “implementation”, “case”, and any other terms which may connote an embodiment, as used herein to describe specific features or configurations, are not intended to limit any of the associated features or configurations to a specific or separate embodiment or examples, and should not be interpreted to suggest that such features or configurations cannot be combined with features or configurations described with reference to other examples, variations, aspects, examples, configurations, implementations, cases, and so forth. In other words, features described herein with reference to a specific example (e.g., embodiment, variation, aspect, configuration, implementation, case, etc.) can be combined with features described with reference to another example. Precisely, one of ordinary skill in the art will readily recognize that the various examples or examples described herein, and their associated features, can be combined with each other.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa. The word “exemplary” is used herein to mean “serving as an example or illustration.” Any aspect or design described herein as “exemplary” is not necessarily to be construed as preferred or advantageous over other aspects or designs. Moreover, claim language reciting “at least one of” a set indicates that one member of the set or multiple members of the set satisfy the claim.

1. A method comprising:
receiving, over a network, at least one attribute associated with a sensor;
generating a unique sensor identifier based on the at least one attribute associated with the sensor;
sending, over the network, the unique sensor identifier to the sensor, the unique sensor identifier to replace a current sensor identifier;
receiving, over the network, a message from the sensor;
determining, whether the message includes the unique sensor identifier; and
in response to the determining, performing an action.

2. The method of claim 1, wherein the unique sensor identifier is a fixed-length.

3. The method of claim 1, wherein the unique sensor identifier has an arbitrary length.

4. The method of claim 3, wherein the arbitrary length is determined based upon various lengths of the at least one attribute of the sensor or a host component of the sensor.

5. The method of claim 1, wherein the unique sensor identifier is a hash value.

6. The method of claim 5, wherein the determining includes comparing the hash value with a sensor identifier received with the message.

7. The method of claim 6, wherein the action includes generating a warning when the sensor identifier received with the message is not the hash value.

8. The method of claim 1, wherein the action includes generating a warning when the unique sensor identifier is not included in the message.

9. The method of claim 1, further comprising:
receiving at least one subsequent message from the sensor;
determining that an identifier associated with the at least one subsequent message is inconsistent with the unique sensor identifier; and
generating a warning report.

10. The method of claim 1, wherein the at least one attribute associated with the sensor includes at least one of host name, media access control address, or basic input/output system universally unique identifier of a host component.

11. A system comprising:
at least one processor; and
at least one memory storing instructions, which when executed by the at least one processor, causes the system to:
receive, over a network, at least one attribute associated with a sensor;
generate a unique sensor identifier based on the at least one attribute associated with the sensor;
send, over the network, the unique sensor identifier to the sensor, the unique sensor identifier to replace a current sensor identifier;
receive, over the network, a message from the sensor;
determine, whether the message includes the unique sensor identifier; and
in response to the determining, perform an action.

12. The system of claim 11, wherein the unique sensor identifier is a fixed-length.

13. The system of claim 11, wherein the unique sensor identifier has an arbitrary length.

14. The system of claim 13, wherein the arbitrary length is determined based upon various lengths of the at least one attribute of the sensor or a host component of the sensor.

15. The system of claim 11, wherein the unique sensor identifier is a hash value.

16. The system of claim 15, wherein the determining includes comparing the hash value with a sensor identifier received with the message.

17. The system of claim 16, wherein the action includes generating a warning when the sensor identifier received with the message is not the hash value.

18. The system of claim 11, wherein the action includes generating a warning when the unique sensor identifier is not included in the message.

19. The system of claim 11, further comprising instructions which when executed cause the system to:
receive at least one subsequent message from the sensor;
determine that an identifier associated with the at least one subsequent message is inconsistent with the unique sensor identifier; and
generate a warning report.

20. The system of claim 11, wherein the at least one attribute associated with a sensor includes at least one of host name, media access control address, or basic input/output system universally unique identifier of a host component.
